(19) United States
(12) Patent Application Publication
(10) Pub. No.: US 2025/0181343 A1
(43) Pub. Date: Jun. 5, 2025

(54) Method for Updating a System Program in an Automation System

(71) Applicant: Siemens Aktiengesellschaft, Muenchen (DE)

(72) Inventor: Thomas GROSCH, Roßtal (DE)

(21) Appl. No.: 18/967,819

(22) Filed: Dec. 4, 2024

(30) Foreign Application Priority Data
Dec. 5, 2023 (EP) 23214231

(51) Int. Cl. G06F 8/65; G06F 8/61

(52) U.S. Cl. CPC G06F 8/65; G06F 8/63

(57) ABSTRACT

A method for updating a system program in an automation system includes a) executing a first control program installed on a first system program on a first processing instance in a first subsystem of the automation system and executing a second control program installed on a second system program on a first processing instance in a second subsystem of the automation system, b) in each case, providing a second processing instance in the first and second subsystem, loading an updated version of the first and second system programs onto a respective second processing instance and starting respective second processing instances in parallel to step a), and c) updating a third control program dependent on a memory image of all status information of the first control program and updating a fourth control program dependent on a memory image of all status information of the second control program.

### BACKGROUND OF THE INVENTION

### 1. Field of the Invention

The present invention relates to a method for updating a system program in an automation system, a computer program product and an automation system.

### 2. Description of the Related Art

Redundant systems are often used in automation environments. These are intended to reduce possible downtimes of the automation system (also referred to here as “technical system”). However, downtimes are not only caused by failures in the actual automation system. Necessary maintenance work also frequently leads to system downtimes. One type of such maintenance work is updates to the system software (hereinafter, also referred to as “firmware” or “FW” or “system program”) that are required to rectify errors or to retrofit new functions. These usually force the automation system to stop. This is particularly disruptive in the case of redundant automation systems and contradicts the expectation of a customer.

In the widely used automation system S7 4xxH from SIEMENS, it is possible to update the system software without interrupting the control of the automation system. However, the automation system temporarily exits redundant operation for this purpose. From the point of view of the customer, reliability is temporarily lost and this likewise contradicts the expectation of the customer.

### SUMMARY OF THE INVENTION

In view of the foregoing, it is an object of the present invention to provide a method that improves on how updates to an automation system are performed.

This and other objects and advantages are achieved in accordance with the invention by a method for updating a system program in an automation system comprising a) executing a first control program installed on a first system program on a first processing instance in a first subsystem of the automation system and executing a second control program installed on a second system program on a first processing instance in a second subsystem of the automation system, where the respective first processing instances of the first and second subsystems are synchronized with one another via a synchronization line, where the first processing instance of the first subsystem controls a technical system and the first processing instance of the second subsystem takes over control if the first processing instance of the first subsystem fails.

The method additionally includes b) in each case, providing a second processing instance in the first and second subsystems, loading an updated version of the first and second system programs onto the respective second processing instances and starting the respective second processing instances in parallel to step a), where a third control program is installed on the updated version of the first system program and a fourth control program is installed on the updated version of the second system program, and c) updating the third control program dependent on a memory image of all status information of the first control program and updating the fourth control program dependent on a memory image of all status information of the second control program.

This advantageously enables in particular the firmware to be updated, where this means there is practically no downtime of the automation system, on the one hand, and also ensures redundant operation of the system during the update, on the other.

Updating a system program in particular means importing a firmware update. In the present disclosure, “system program” in particular means an operating system, such as an operating system of a programmable logic controller. On the other hand, the “control program” is a user-specific software (application) that is installed on the system program.

The first and second system programs preferably have identical source code. Likewise, the updated versions of the first and second system programs preferably have identical source code. In the updated version, for example, errors may have been corrected compared to the old version or functions may have been added. The first and second system programs or the updated versions in each case may also be formed as different instances of the same software. The first, second, third and fourth control programs preferably have identical source code.

The first and second control programs executed in step a) each have threads (also referred to as “activity carriers”) and input and output variables that are saved in the (possibly virtualized) working memory of the respective first processing instance. For example, an output variable of the first control program can be representative of an output voltage that is output to the technical system. After installation of the third and fourth control programs in step b), these are started on the respective second processing instance, but not yet executed. The start causes the corresponding data structures to be generated in the (possibly virtualized) working memory of the respective second processing instance. However, the corresponding threads remain at the starting point because the third and fourth control programs are not yet executed. In the update process in accordance with step c), the status information is transmitted. That is, the states of corresponding threads and the values of corresponding input and output values are transmitted in the form of a copy from the first control program to the third control program and from the second control program to the fourth control program. After the transmission process, therefore, the third control program as a whole is in the same state as the first control program before the transmission. Likewise, the fourth control program as a whole is in the same state as the second control program before the transmission. Thus, from this point onward, the second and fourth programs can each control the technical system when they are executed by the respective second processing instance.

The first and second subsystems are preferably physically (and not just virtually) different systems. In particular, the first and second subsystems have different hardware. The first and second subsystems are preferably spaced apart from one another and, to be precise, such that an expected incident of physical damage due to external influences (for example, a fire) cannot affect both subsystems and/or cannot spread between the subsystems. In particular, the subsystems can be located in different fire compartments. This ensures a high level of failure safety.

In some embodiments, the first and second subsystems can be implemented in the immediate vicinity of the actuated technical system or in a cloud or in different clouds. In the latter case, the first and second subsystems are connected to a technical system by a high-availability data line.

In the present disclosure, a “processing instance” should preferably be understood to mean a unit of (physical or virtualized) hardware (for example, CPU, working memory and/or interfaces). The corresponding system program (as the operating system) is first installed on this. In turn, the corresponding control program is installed on the corresponding system program. The processing instance executes the system program and the control program and generates corresponding outputs (in particular to the technical system, for example, control signals to actuators) dependent on inputs (in particular from the technical system, for example, in the form of sensor measurements).

The first and second subsystems can be connected to the technical system via a (physical or virtualized) bus, such as Ethernet or Fieldbus. In particular, there is a connection to sensors of the technical system that provide the aforementioned inputs. There is also a connection to actuators of the technical system to which the aforementioned outputs are provided.

The technical system is, for example, a tunnel system, a track system, a production system, a process engineering system, a conveyor system, and/or a ship.

The synchronization line is, for example, a bus that particularly has an optical waveguide.

In accordance with one embodiment, before the update in step c), the respective first processing instances in the first and second subsystems are stopped insofar as the execution of the first and second control programs is concerned.

In other words, the first processing instances are in downtime, i.e., in particular they do not generate any changes to their outputs (i.e., briefly, no changed actuation of the technical system), during the update in accordance with step c). Due to the high data transmission speed within the respective subsystem, the downtime should only last a few milliseconds. Advantageously, there is no subsequent catch-up phase. Such a phase is required, for example, in the case of trailing operation, as described in EP 2 667 269 A1.

The control of the technical system is assumed by the second processing instance of the first or second subsystem immediately after completion of the update process in accordance with step c), where the second processing instance of the other subsystem each represents the redundancy, i.e., it takes over if a fault or failure occurs. Accordingly, the first processing instances also no longer run after step c), but remain in an “idle mode” or are switched off completely.

In accordance with a further embodiment, the execution of the second (or fourth) control program on the first (or second) processing instance in the second subsystem is established to trail the execution of the first (or third) control program on the first (or second) processing instance in the first subsystem.

A trailing operation is, for example, described in principle in EP 2 657 797 A1. This ensures that both subsystems always have the same internal state, albeit at different times. This allows the use of communication links that are slow compared to data processing in the processing instances.

The synchronization of the first processing instances of the first and second subsystems in accordance with step a) can include: transmitting process input values of the first processing instance of the first subsystem, transmitting releases of the first processing instance of the first subsystem which indicate which processing steps of the first control program have already been processed, and synchronizing the second control program dependent on the transmitted process input parameters and releases.

The use of process input values and releases is, for example, described in EP 2 657 797 A1 and represents a simple way for the second subsystem to trail the first subsystem. The releases ensure that the trailing second subsystem runs through the same “thread mountain” as the leading first subsystem. This also means that “thread changes” occur at the same points in the control programs. However, in the present case, synchronization can also be achieved in other ways. Nonetheless, it is important that a “bumpless” failover is preferably ensured. This avoids downtimes of the controlled technical system.

Step c) can be followed by step d): executing the updated third and fourth control program on the updated version of the first and second system programs on the respective second processing instance in the first and second subsystems, where the second processing instances of the first and second subsystems are synchronized with one another via a synchronization line, and where the second processing instance of the first (or: first or second) subsystem controls the technical system and the second processing instance of the second (or: in each case other) subsystem assumes control if the second processing instance of the first (or: first or second) subsystem fails.

The synchronization of the second processing instances of the first and second subsystems in accordance with step d) can include: transmitting process input values of the second processing instance of the first subsystem, transmitting releases of the second processing instance of the first subsystem which indicate which processing steps of the third control program have already been processed, synchronizing the fourth control program dependent on the transmitted process input parameters and releases.

In accordance with a further embodiment, the respective second processing instances in accordance with step b) are started dependent on configuration data containing information relating to the configuration of the technical system.

In accordance with a further embodiment, the control program to be installed in step b) is stored in each of the first and second subsystems (or in associated cloud storage). This in particular allows the interfaces of the second processing instances to be configured for the technical system before the update process in accordance with step c) begins. The configuration data can in particular contain information about the connected sensors and actuators of the technical system. Insofar as a technical system is referred to here, this particularly means the peripherals from the point of view of the automation system, i.e., the components of the technical system (such as sensors and actuators), with which the automation system or the first and second subsystems (again the first or second processing instances) communicate.

In accordance with yet a further embodiment, after starting the respective second processing instances according to step b), a passive connection of the first processing instance of the second subsystem is interrupted, and then the started second processing instance of the first subsystem establishes a passive connection to the technical system.

In the present disclosure, a “passive” connection is one in which the peripherals or technical system ignore the outputs and mark the inputs as invalid. An “active” connection, on the other hand, is one in which the peripherals forward the output to the actuators and mark the input values as valid.

In accordance with a further embodiment, after the updating according to step c), the second processing instance of the first subsystem establishes (in particular immediately) an active connection to the technical system and the second processing instance of the second subsystem establishes a passive connection to the technical system. As a result, a redundant automation system is once again available.

In accordance with a still further embodiment, the first and second subsystems each have a hypervisor that provides the first and second processing instances. This enables the plurality of processing instances to be easily provided and to share system resources.

In accordance with a further embodiment, the first and second subsystems each have a programmable logic controller, a power supply and/or an interface to the technical system. This advantageously results in subsystems that are independent of one another.

The objects and advantages are also achieved in accordance with the invention by a computer program product that comprises instructions which, when the program is executed by a processor of a computer, cause the computer to execute the method in accordance with the disclosed embodiments.

A computer program product, such as, for example, a computer program means can, for example, be provided or delivered as a storage medium, such as a memory card, USB Stick, CD-ROM, DVD, or also in the form of a downloadable file from a server in a network. This can, for example, be done in a wireless communication network by transmission of a corresponding file with the computer program product or the computer program means. In the present disclosure, the “computer” can also comprise a plurality of (possibly physically separate) computing apparatuses (such as programmable logical controllers).

The objects and advantages are also achieved in accordance with the invention by an automation system that includes: a first subsystem with a first processing instance that is configured to control a first control program installed on a first system program in order thereby to control a technical system, a second subsystem with a first processing instance that is configured to execute a second control program installed on a second system program in order thereby to control the technical system if the first processing instance of the first subsystem fails, and a synchronization line that is configured to synchronize the respective first processing instance of the first and second subsystems with one another, where the first and second subsystems are each configured to provide a second processing instance and each have an interface via which an updated version of the first and second system programs can be loaded onto the respective second processing instance and a third control program can be installed on the updated version of the first system program and a fourth control program can be installed on the updated version of the second system program, and where the first and second subsystems are configured to update the third control program dependent on a memory image of all status information of the first control program and to update the fourth control program dependent on a memory image of all status information of the second control program.

The interface via which an updated version of the first and second system programs can be loaded onto the respective second processing instance can be formed as any known data interface, for example a port.

The embodiments and features described for the proposed method apply accordingly to the proposed automation system and computer program product.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

Further advantageous embodiments and aspects of the invention are the subject matter of the subclaims and the exemplary embodiments of the invention described in the following. The invention is explained below in more detail with reference to preferred embodiments and with reference to the attached, in which:

FIG. 1 shows an exemplary automation system in preparation for the FW update in redundant operation;

FIG. 2 shows the loading for the new FW versions following the state shown in FIG. 1;

FIG. 3 shows the switchover of the passive peripheral connection following the state shown in FIG. 2;

FIG. 4 shows the update following the state shown in FIG. 3;

FIG. 5 shows the takeover of the peripherals following the status shown in FIG. 4;

FIG. 6 shows the situation after the FW update; and

FIG. 7 shows a flow chart of a method in accordance with FIGS. 1 to 6.

### DETAILED DESCRIPTION OF THE EXEMPLARY EMBODIMENTS

Elements that are the same or have the same functions have been provided with the same reference symbols, unless stated otherwise.

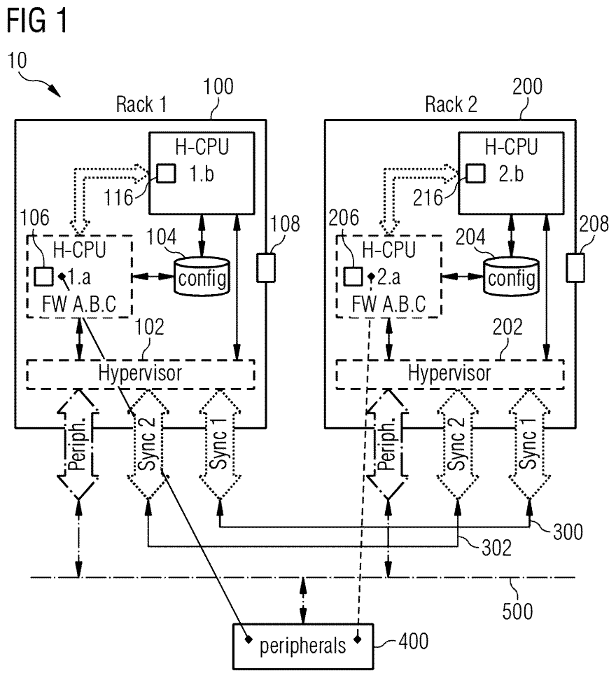

FIG. 1 shows, in an initial state for the present method, a redundant automation system 10 consisting of a first subsystem 100 and a second subsystem 200. The subsystems 100, 200 can be in the form of separate racks (here referred to as “rack 1” and “rack 2”), which each comprise a programmable logic controller, not shown in further detail, a power connection and interfaces to the peripherals 400.

A feature of the two subsystems 100, 200 is preferably a hypervisor 102, 202 that virtualizes the hardware (e.g., processor, memory, and/or interfaces). Herein, a plurality of instances of the system program (FW) can be executed in parallel on the same hardware. In the present example, these are the first and second processing instances H-CPU 1a, H-CPU 1b on the hypervisor 102 (subsystem 100) and the first and second processing instances H-CPU 2a, H-CPU 2b on the hypervisor 202 (subsystem 200).

The two subsystems 100, 200 are connected to one another via synchronization lines 300, 302 that can be formed as optical waveguides. The peripherals 400 (also referred to as “technical system” in the present disclosure) are attached to the two subsystems 100, 200 via a bus 500. Herein, the solid line represents the active connection and the dashed line represents the passive connection (with PROFINET Fieldbus Primary or Backup Application Relation-“AR”).

A first control program 106 or second control program 206 is installed on each of the first processing instances H-CPU 1a, H-CPU 2a of the first and second subsystems 100, 200, on the system program FW there, where the programs 106, 206 may have identical source codes. The system program FW represents the operating system, whereas the control program 106, 206 is an application that is configured by the user and is suitable for actuating the technical system 400 in the desired manner. The current configuration of the automation system 10, in particular of the technical system 400, is stored in a memory in the two subsystems 100, 200 in the form of a configuration file 104, 204. The memory can further contain a copy of the control program 106, 206, in particular as an executable file.

Before the update process, both subsystems 100, 200 execute in redundant operation with the FW version A.B.C. The peripherals or the technical system 400 are actuated by the control program 106 or the processing instance H-CPU 1a or receive data (for example, measurement data) therefrom. The two subsystems 100, 200 or the processing instances H-CPU 1a, H-CPU 2a are, for example, synchronized in accordance with the method described in EP 2 657 797 A1, where the processing instance H-CPU 1a is the leading instance and the processing instance H-CPU 2a is the trailing instance. If the subsystem 100 fails, then the subsystem 200 takes over in the sense of a bumpless failover. That is, the control program 206 of the processing instance H-CPU 2a assumes control of the technical system 400 from then on.

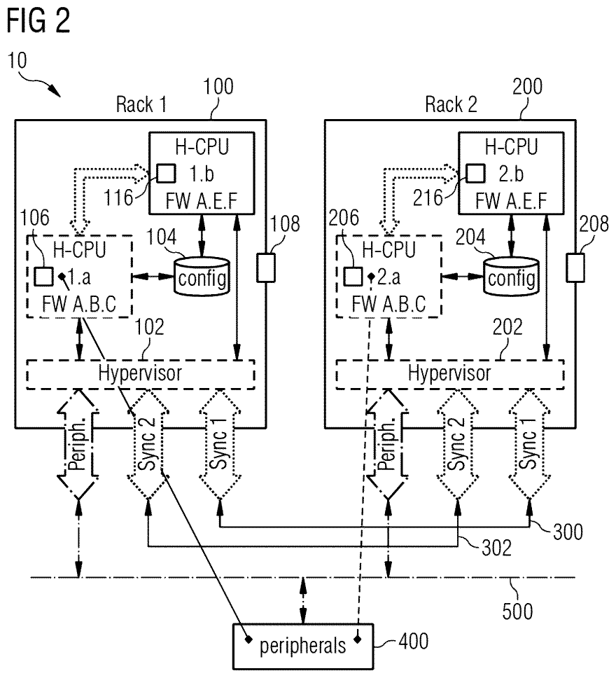

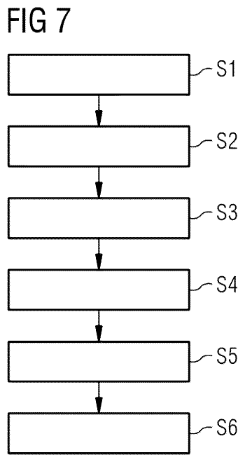

In the first step S1 (see FIGS. 2 and 7), the new FW version A.E.F is loaded onto the second processing instance H-CPU 1b in the first subsystem 100 and onto the second processing instance H-CPU 2b in the second subsystem 200, where the new FW-version A.E.F is provided via a respective interface 108 or 208 (for example, an Ethernet interface, and/or USB interface) of the subsystems 100, 200. In some embodiments, the processing instances H-CPU 1b and 2b can only be provided when an FW update is pending or can be provided immediately upon initial commissioning of the automation system 10.

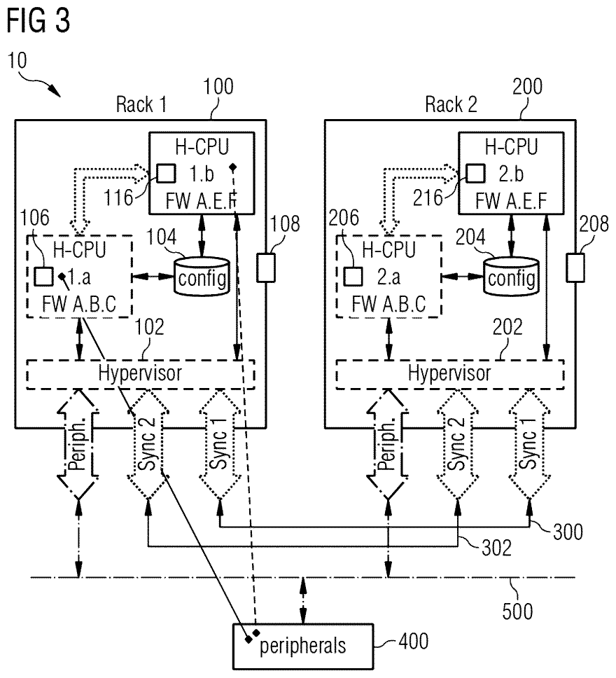

In the second step S2 (see FIGS. 3 and 7), the two processing instances H-CPU 1b and H-CPU 2b start with the new FW version A.E.F. The two processing instances H-CPU 1b and H-CPU 2b are ramped up based on the currently available configuration file 104 or 204. Third and fourth control programs 116, 216 are installed and started based on the configuration file 104 or 204 on the new FW version A.E.F of the processing instances H-CPU 1b or H-CPU 2b.

When the processing instances H-CPU 1b and H-CPU 2b have been powered up, the processing instance H-CPU 2a deactivates its passive connection to the peripherals 400 (Backup AR) in a step S3 (see FIGS. 3 and 7). A new passive connection (dashed line in FIG. 3) is established by the processing instance H-CPU 1b. The two processing instances H-CPU 1b and 2b do not process any of the control programs 116, 216 at this time.

In a step S4, the control programs 116, 216 on the processing instances H-CPU 1b and H-CPU 2b are updated in parallel on both subsystems 100, 200. This occurs dependent on a memory image of the control programs 106, 206 on the processing instances H-CPU 1a and 2a. That is, an update process is performed locally. The processing instances H-CPU 1a and 1b or 2a and 2b each perform this update process with the same system state.

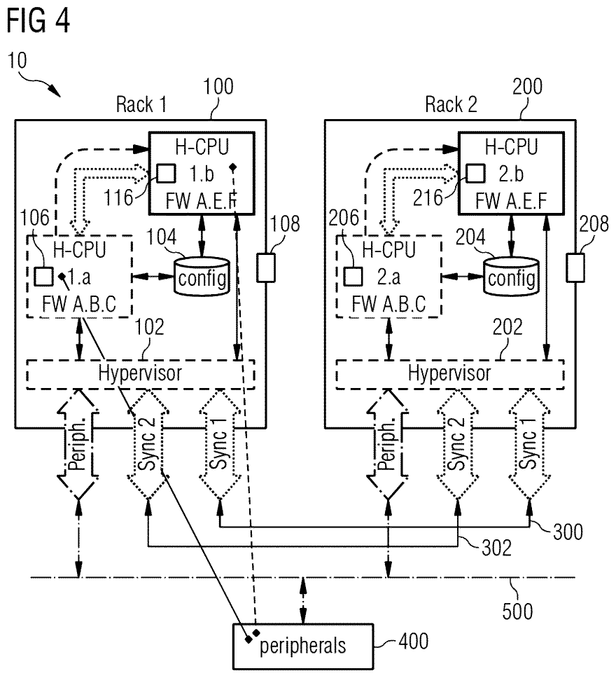

For the update process, where relevant for the current state of the control programs 106, 206, the memory image of the processing instances H-CPU 1a and H-CPU 2a is transmitted to the processing instance H-CPU 1b or 2b (dashed arrow in FIG. 4), whereas, once again, where relevant for the current state of the control programs 106, 206, processing on the processing instances 1a and 2a goes into downtime, i.e., the process is not controlled. In contrast, in the update method from EP 2 667 269 A1, the leading processing instance continues to execute directly after the memory image has been created. However, in the present case, the two update processes each occur locally in a subsystem 100 or 200. As a result, the transmission of the memory image itself takes hardly any time. This is substantially a matter of copying memory contents. Therefore, the downtime during the transmission of the memory image to the processing instance H-CPU 1b and 2b is acceptable (in the millisecond range).

The advantage of this procedure consists in the fact that there is no catch-up phase for the two local update processes, as is necessary with the approach described in EP 2 667 269 A1. This catch-up phase is difficult to accomplish with different versions of the system program. With the present method, either the old FW or the new FW is active. Therefore, the newer FW is not required to support synchronized operation with the old FW and is therefore simpler.

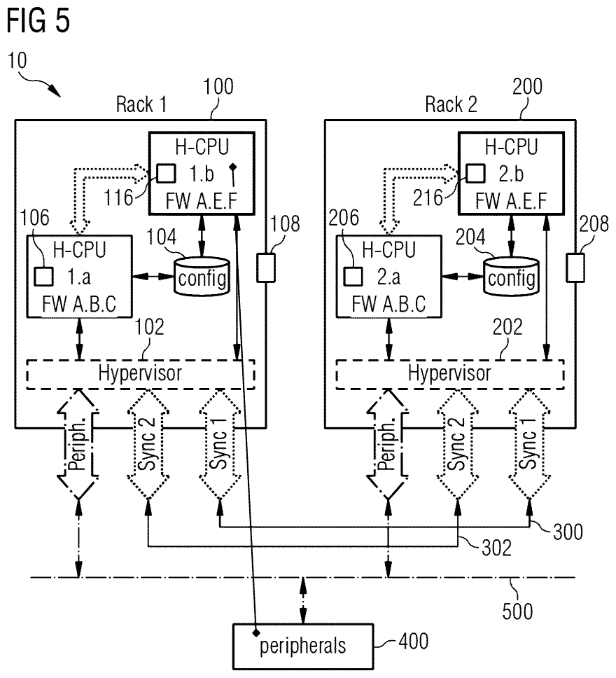

Immediately after the update process, the active peripheral connection is switched over to the processing instance H-CPU 1b (step S5 in FIG. 7 corresponding to the depiction in FIG. 5). As a result, the processing instance H-CPU 1b now has access to the peripherals 400. From now on, the processing instances H-CPU 1b and 2b operate in redundant mode, for example, as described in EP 2 657 797 A1. The processing instances H-CPU 1a and 2a are terminated and are now inactive.

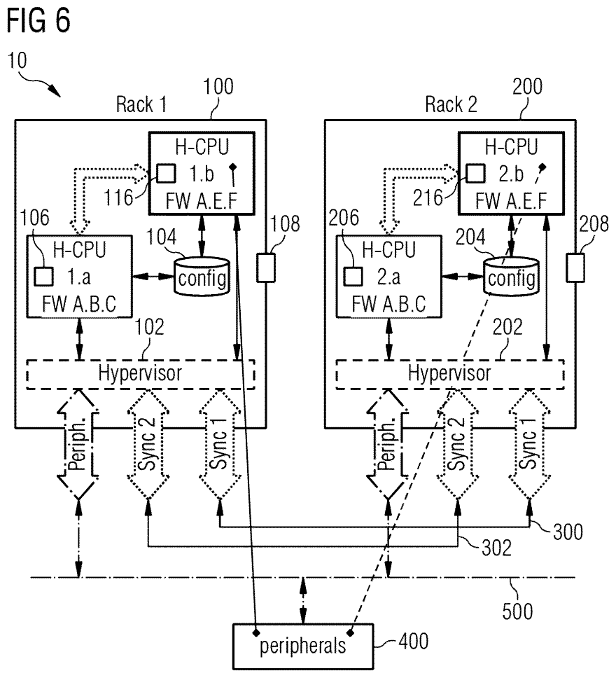

In a step S6 (FIGS. 6 and 7), the passive peripheral connection (dashed line in FIG. 6) is preferably re-established by the processing instance H-CPU 2b. Therefore, the peripherals 400 are once again redundantly connected to the two subsystems 100, 200. The automation system 10 now executes in redundant mode with the FW version A.E.F. A further FW update can now be performed in a similar way with the processing instances H-CPU 1a and 2a.

Thus, while there have been shown, described and pointed out fundamental novel features of the invention as applied to a preferred embodiment thereof, it will be understood that various omissions and substitutions and changes in the form and details of the methods described and the devices illustrated, and in their operation, may be made by those skilled in the art without departing from the spirit of the invention. For example, it is expressly intended that all combinations of those elements and/or method steps that perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A method for updating a system program in an automation system, the method comprising:
a) executing a first control program installed on a first system program on a first processing instance in a first subsystem of the automation system and executing a second control program installed on a second system program on a first processing instance in a second subsystem of the automation system, a respective first processing instance of the first and second subsystems being synchronized with one another via a synchronization line, and the first processing instance of the first subsystem controlling a technical system and the first processing instance of the second subsystem assuming control if the first processing instance of the first subsystem fails;
b) in each case, providing a second processing instance in the first and second subsystems, loading an updated version of the first and second system programs onto a respective second processing instance and starting the respective second processing instances in parallel to step a), a third control program being installed on the updated version of the first system program and a fourth control program being installed on the updated version of the second system program; and
c) updating the third control program dependent on a memory image of all status information of the first control program and updating the fourth control program dependent on a memory image of all status information of the second control program.

2. The method as claimed in claim 1, wherein before the update in step c), the respective first processing instances in the first and second subsystems are stopped insofar as execution of the first and second control programs is concerned.

3. The method as claimed in claim 1, wherein the execution of the second control program on the first processing instance in the second subsystem is established to trail the execution of the first control program on the first processing instance in the first subsystem.

4. The method as claimed in claim 2, wherein the execution of the second control program on the first processing instance in the second subsystem is established to trail the execution of the first control program on the first processing instance in the first subsystem.

5. The method as claimed in claim 1, wherein the synchronization of the first processing instances of the first and second subsystems in accordance with step a) includes:
transmitting process input values of the first processing instance of the first subsystem;
transmitting releases of the first processing instance of the first subsystem which indicate which processing steps of the first control program have already been processed; and
synchronizing the second control program dependent on the transmitted process input parameters and releases.

6. The method as claimed in claim 2, wherein the synchronization of the first processing instances of the first and second subsystems in accordance with step a) includes:
transmitting process input values of the first processing instance of the first subsystem;
transmitting releases of the first processing instance of the first subsystem which indicate which processing steps of the first control program have already been processed; and
synchronizing the second control program dependent on the transmitted process input parameters and releases.

7. The method as claimed in claim 3, wherein the synchronization of the first processing instances of the first and second subsystems (100, 200) in accordance with step a) includes:
transmitting process input values of the first processing instance of the first subsystem;
transmitting releases of the first processing instance of the first subsystem which indicate which processing steps of the first control program have already been processed; and
synchronizing the second control program dependent on the transmitted process input parameters and releases.

8. The method as claimed in claim 1, wherein the respective second processing instances in accordance with step b) are started dependent on configuration data containing information relating to the configuration of the technical system; and wherein at least one of the configuration data and the control program to be installed in step b) is each stored in the first and second subsystems.

9. The method as claimed in claim 1, wherein passive connection of the first processing instance of the second subsystem is interrupted and the started second processing instance of the first subsystem subsequently establishes a passive connection to the technical system after starting the respective second processing instances in accordance with step b).

10. The method as claimed in claim 1, wherein the second processing instance of the first subsystem establishes an active connection to the technical system and the second processing instance of the second subsystem establishes a passive connection to the technical system after said updating in accordance with step c).

11. The method as claimed in claim 1, wherein the first and second subsystems each include a hypervisor which provides the first and second processing instances.

12. The method as claimed in claim 1, wherein the first and second subsystems each include at least one of a programmable logic controller, a power supply and an interface to the technical system.

13. A non-transitory computer-readable medium encoded with program instructions which, when is executed by a processor of a computer, causes the computer to update a system program in an automation system, program instructions comprising:
a) program code for executing a first control program installed on a first system program on a first processing instance in a first subsystem of the automation system and executing a second control program installed on a second system program on a first processing instance in a second subsystem of the automation system, a respective first processing instance of the first and second subsystems being synchronized with one another via a synchronization line, and the first processing instance of the first subsystem controlling a technical system and the first processing instance of the second subsystem assuming control if the first processing instance of the first subsystem fails;
b) program code for, in each case, providing a second processing instance in the first and second subsystems, loading an updated version of the first and second system programs onto a respective second processing instance and starting the respective second processing instances in parallel to step a), a third control program being installed on the updated version of the first system program and a fourth control program being installed on the updated version of the second system program; and
c) program code for updating the third control program dependent on a memory image of all status information of the first control program and updating the fourth control program dependent on a memory image of all status information of the second control program.

14. An automation system comprising:
a first subsystem including a first processing instance which is configured to execute a first control program installed on a first system program to control a technical system;
a second subsystem including a first processing instance which is configured to execute a second control program installed on a second system program to control the technical system if the first processing instance of the first subsystem fails; and
a synchronization line which is configured to synchronize the respective first processing instance of the first and second subsystems with one another;
wherein the first and second subsystems are each configured to provide a second processing instance and each includes an interface via which an updated version of the first and second system programs is loadable onto a respective second processing instance and a third control program is installable on the updated version of the first system program and a fourth control program is installable on the updated version of the second system program; and
wherein the first and second subsystems are configured to update the third control program dependent on a memory image of all status information of the first control program and to update the fourth control program dependent on a memory image of all status information of the second control program.
